(19) United States
(12) Patent Application Publication
(10) Pub. No.: US 2004/0180279 A1
(43) Pub. Date: Sep. 16, 2004

(54) Electrophotographic photoconductor and method of manufacturing the same

(76) Inventors: Ikuo Takaki, Nagano (JP); Yoichi Nakamura, Nagano (JP); Koichi Aizawa, Nagano (JP)

Correspondence Address: DARBY & DARBY P.C., P. O. BOX 5257, NEW YORK, NY, 10150-5257, US

(21) Appl. No.: 09/942,362

(22) Filed: Aug. 29, 2001

(30) Foreign Application Priority Data
Sep. 1, 2000 (JP) 2000-265913

(51) Int. Cl. G03G 5/06; G03G 5/047

(52) U.S. Cl. 430/58.05; 430/70; 430/133

(57) ABSTRACT

The object of the present invention is to provide an electrophotographic photoconductor that has sufficient resistance against ozone and exhibits improved stability in electrical characteristics. Another object of the invention is to provide a method for manufacturing such a photoconductor.

An electrophotographic photoconductor of the present invention has a conductive substrate and a photosensitive layer on the substrate, in which the photosensitive layer contains a compound represented by the formula (I),

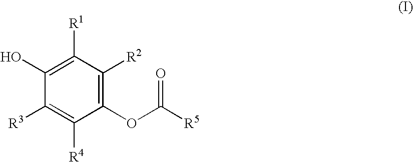

wherein each of R¹ to R⁴ are independently selected from the group consisting of a hydrogen atom, a halogen atom, an alkyl group of 1 to 4 carbon atoms, an alkoxyl group, an alkyl halide group, an alkoxyl halide group, or an optionally substituted aryl group, and R⁵ represents an optionally substituted alkyl group or an optionally substituted aryl group. The resulting electrophotographic photoconductor has sufficient resistance against ozone and exhibits excellent stability in electrical characteristics.

### BACKGROUND OF THE INVENTION

The present invention relates to an electrophotographic photoconductor (also simply called “a photoconductor”) used in electrophotographic apparatuses, such as printers, copiers and facsimile machines. In particular, the present invention relates to such a photoconductor that exhibits excellent resistivity against ozone by virtue of improved additives. The present invention also relates to a method for manufacturing such a photoconductor.

A photoconductor is required to have functions of maintaining surface charges in the dark, generating charges upon receipt of light, and transporting the generated charges upon receipt of light. Conventional photoconductors include a so-called single-layer type photoconductor having these functions in a single photosensitive layer, and a so-called laminated-layer type photoconductor having function-separated two layers. In the laminated-layer type photoconductor, a first layer mainly serves to generate charges upon receipt of light and a second layer serves to maintain surface charges in the dark and transport the generated charges upon receipt of light.

To form images by an electrophotographic method using the above types of photoconductors, the Carlson process, for example, is applied. The image formation by this process is performed by charging the photoconductor in the dark by a corona discharge, forming an electrostatic latent image, such as characters or drawings of an original, on the charged surface of the photoconductor, developing the thus formed electrostatic latent images by means of toner particles representing the image onto a support, such as paper. After the toner transfer, remaining toner particles are removed and residual electrostatic charges are removed by erase exposure. This allows the photoconductor to be used again.

Conventional photosensitive materials of the photoconductors include inorganic photoconductive substances, such as selenium, selenium alloys, zinc oxide, and cadmium sulfide dispersed in a resin binder. Additionally, organic photoconductive substances, such as poly-N-vinylcarbazole, 9,10-anthracenediole polyester, hydrazone, stylbene, butadiene, benzidine, phthalocyanine and bisazo compounds have been also used by dispersing in a resin binder, or by deposition in a vacuum or sublimation.

In recent years, a number of improvements in materials constituting a photoconductor have been made, including in the above-mentioned materials, for providing photoconductors with higher performances. However, any known photoconductor does not completely satisfy all of the required characteristics. Thus, further improvements are needed, including in those areas discussed below.

Stability of electrical characteristics in repeated use is one of the properties in which improvement is eagerly sought. Specifically, change in electrical potential, bright potential in particular, of a photoconductor in continuous and repeated practical operation must be avoided because the variation causes deterioration of quality in printed characters and copied images. This potential variation may be attributed to fatigue and degradation of the organic materials that are caused by ozone, light and heat generated by continuous operation in a practical machine. Moreover, this potential variation may also caused by variation in temperature and humidity in the operating environment. Especially, improvement of resistance to ozone that is generated within the practical machine in continuous operation is an essential requirement to obtain excellent characteristics in repeated use.

Until now, studies have been made to develop additives for improving resistance to ozone—the additives are generally called “antioxidants”. The studies have proposed various compounds. Among them, a phenolic antioxidant exhibits distinct effect and is one of the widely used materials, as disclosed in Japanese Unexamined Patent Application Publication H10-133400.

If this antioxidant is added more than minimum requirement intending to further improve ozone resistance, then, in the initial electrical characteristic or after continuous use in the practical machine, residual potential shows a clearly high value, resulting in possible unsatisfactory photoconductor characteristics. Thus, it is difficult to further improve ozone resistance by only using ever proposed conventional antioxidants. That is, novel and more effective antioxidants are required.

### OBJECTS AND SUMMARY OF THE INVENTION

It is therefore an object of the present invention to provide an electrophotographic photoconductor which solves the above problems.

It is a further object of the present invention to provide an electrophotographic photoconductor that exhibits high ozone resistance and improved stability in electrical characteristic during repeated use.

It is another object of the invention to provide a method for manufacturing such a photoconductor.

To solve the problem, an electrophotographic photoconductor according to the present invention comprises a conductive substrate and a photosensitive layer on the conductive substrate, the photosensitive layer containing a compound represented by formula (I),

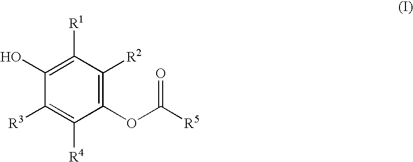

wherein each of R¹ to R⁴ are independently selected from the group consisting of a hydrogen atom, a halogen atom, an alkyl group of 1 to 4 carbon atoms, an alkoxyl group, an alkyl halide group, an alkoxyl halide group, or an optionally substituted aryl group, and R⁵ represents an optionally substituted alkyl group or an optionally substituted aryl group.

In case where the photosensitive layer is a laminated-layer type that comprises a charge generation layer and a charge transport layer, advantageously, at least one of the charge generation layer and the charge transport layer contains the compound represented by formula (I). In this case, the charge generation layer comprises charge generation material and the charge transport layer comprises charge transport material, and advantageously, the compound represented by formula (I) is contained in the charge generation layer in an amount of 0.01 to 20 parts by weight with respect to 100 parts by weight of the charge generation material. Optionally, the compound represented by formula (I) is contained in the charge transport layer in an amount of 0.01 to 20 parts by weight with respect to 100 parts by weight of the charge transport material.

In case the photosensitive layer consists of single layer, advantageously, the compound represented by formula (I) is contained in the single photosensitive layer in an amount of 0.1 to 50 wt % with respect to a solid component of the photosensitive layer.

A method of the invention for manufacturing a photoconductor comprises a step for forming a photosensitive layer by coating a conductive substrate with coating liquid that contains the compound represented by the formula (I).

The coating liquid in the manufacturing method of the invention may be applied to any kind of coating method including dip-coating method and spray-coating method, and shall not be limited to any specific coating method.

The above, and other objects, features and advantages of the present invention will become apparent from the following description read in conjunction with the accompanying drawing, in which like reference numerals designate the same elements.

### BRIEF DESCRIPTION OF THE DRAWING

FIGURE 1 is a schematic cross-sectional view showing an example of a negative-charging function-separated laminated-layer type photoconductor of an embodiment according to the present invention.

### DETAILED DESCRIPTION OF THE INVENTION

Now, the present invention will be described with reference to some specific aspects of the embodiments of the invention.

Specific examples of the compound represented by the general formula (I) in the present invention are given by the following formulas (I-1) to (I-14). These specific compounds are given as individual examples, however the present invention shall not be limited by these compounds.

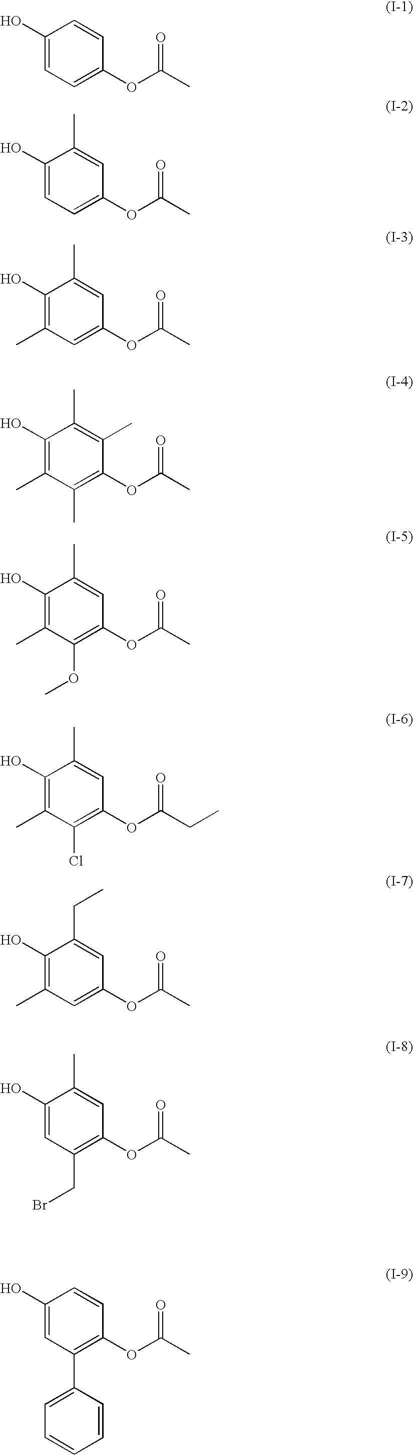

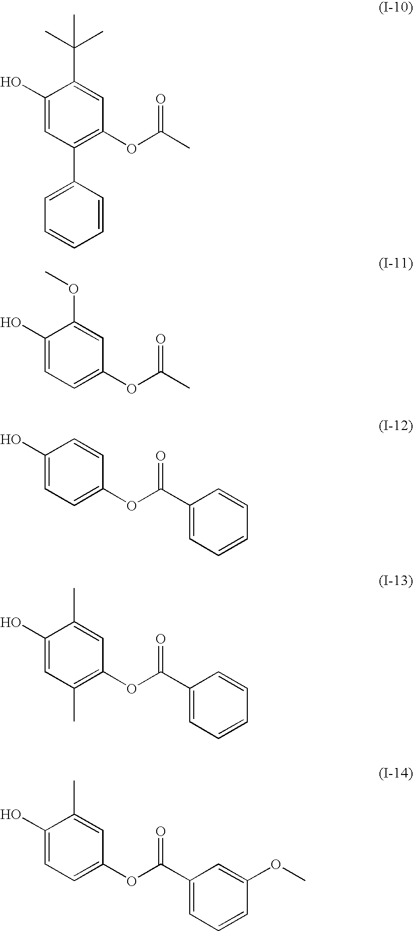

These compounds are known and disclosed in the following references, each of which are incorporated herein by reference. Such a compound used in the present invention may be a commercially available one or may be synthesized according to the description in the following references:

Song Xiaoping et al., Huaxue Shiji, 20(2), 125 (1998),

Harold R. Gerberich, Specification of European Patent No. 178929,

Serge Ratton, Japanese Unexamined Patent Application Publication No. S61-18745, and

David Johnston, Chem. Ind. (London), (24), 1000 (1982).

A photoconductor of the invention may be a single-layer type or laminated-layer type. No limitation is imposed except the basic structure comprising photosensitive layer laminated on a conductive substrate. However, the following description will be made with reference to an example of a laminated-layer type photoconductor.

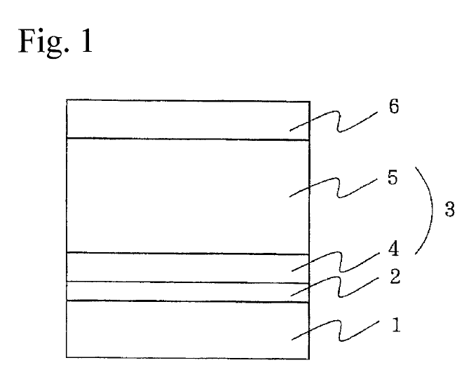

FIGURE 1 is a schematic cross sectional view showing an example of a basic construction of a photoconductor of the invention.

Referring to FIGURE 1, a function-separated laminated-layer type photoconductor comprises a conductive substrate 1, an undercoat layer 2 on the substrate, and a photosensitive layer 3 composed of a charge generation layer 4 and a charge transport layer 5 sequentially laminated in this order. The undercoat layer 2 and a surface protective layer 6 may be provided as desired.

Conductive substrate 1 functions as an electrode of the photoconductor and also functions as a support for the other layers constituting the photoconductor. Conductive substrate 1 may have a cylindrical shape, a planer shape, or a film-like shape, and may be formed of a metal or alloy such as aluminum, stainless steel or nickel, or glass or resin that has been treated to give certain conductivity on the surface.

Undercoat layer 2, which is formed of a layer containing resin as a major component or an oxide film such as alumite, may be provided as required for the purposes of controlling charge injection from the conductive substrate into the photosensitive layer, covering defects on the surface of the substrate, and improving adhesiveness of the photosensitive layer with the substrate. A resin material for undercoat layer 2 may be selected from an insulative polymer such as casein, poly(vinyl alcohol), polyamide, melamine, and cellulose, and a conductive polymer such as polythiophene, polypyrrole, and polyaniline, which may be used alone or in suitable combination. Undercoat layer 2 may further contain a metal oxide such as titanium dioxide or zinc oxide with the resin material.

Charge generation layer 4, which serves to generate charges upon receipt of light, is formed by depositing photoconductive substance as a charge generation material in a vacuum, or by coating with coating liquid in which particles of charge generation material are dispersed in a resin binder. Charge generation layer 4 is desired to generate charges with high efficiency and also to have favorable capability of injecting the generated charges into charge transport layer 5. Namely, the charge injection is desired to be less dependent on electric field, and to be facilitated even under low electric field. The charge generation material may be selected from phthalocyanine compounds, such as X-type metal-free phthalocyanine, τ-type metal-free phthalocyanine, α-type titanylphthalocyanine, β-type titanylphthalocyanine, Y-type titanylphthalocyanine, amorphous type titanylphthalocyanine, and ε-type copperphthalocyanine, azo pigment, anthoanthrone pigment, thiapyrylium pigment, perylene pigment, perynone pigment, squarilium pigment, and quinacridone pigment, which may be used alone or in suitable combination. In addition, selenium or selenium compound may also be used. A favorable substance for the charge generation layer may be selected corresponding to the wave length region of the light source used for the image formation.

The resin binder used in the charge generation layer may be selected from polycarbonate resin, polyester resin, polyamide resin, polyurethane resin, vinyl chloride resin, vinyl acetate resin, phenoxy resin, poly(vinyl acetal) resin, poly(vinyl butyral) resin, polystyrene resin, polysulfone resin, diaryl phthalate resin, methacrylic acid ester resin, and polymers and copolymers of these resins, which may be used in suitable combination. The content of the charge generation material relative to the content of the resin binder in the charge generation layer is in the range of 5 to 500 parts by weight, preferably 10 to 100 parts by weight with respect to 10 parts by weight of the resin binder.

The film thickness of the charge generation layer is determined depending on the light absorption coefficient of the charge generating substance, and is generally controlled to be not more than 1 μm, preferably, not more than 0.5 μm.

Charge generation layer 4 contains charge generation material as a major component, to which charge transport material and others may be added.

Charge transport layer 5 is mainly composed of charge transport material and resin binder. The charge transport material may be selected from a hydrazone compound, a styryl compound, a diamine compound, a butadiene compound, and an indole compound, which may be used alone or in suitable combination. The binder resin used in the charge transport layer may be selected from a polycarbonate resins such as bisphenol A type, bisphenol Z type or bisphenol A biphenyl copolymer, a polystyrene resin, a polyphenylene resin, and any suitable combination of these substances. The content of the charge transport material relative to the content of the resin binder in the charge transport layer is in the range of 2 to 500 parts by weight, preferably 30 to 300 parts by weight with respect to 100 parts by weight of the resin binder. The film thickness of the charge transport layer is preferably held in a range of 3 to 50 μm, more preferably, 15 to 40 μm, so as to maintain a practically effective surface potential. Specific examples of the charge transport material that may be used in the invention are shown by formulas (II-1) to (II-13) below.

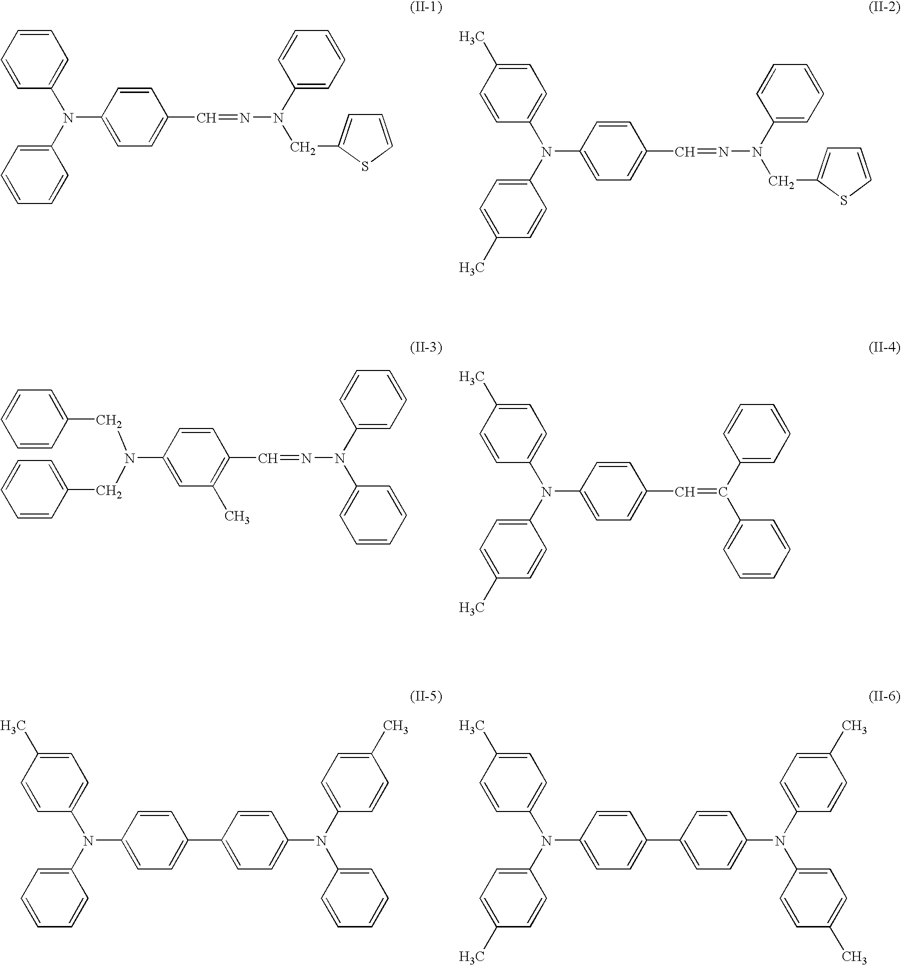

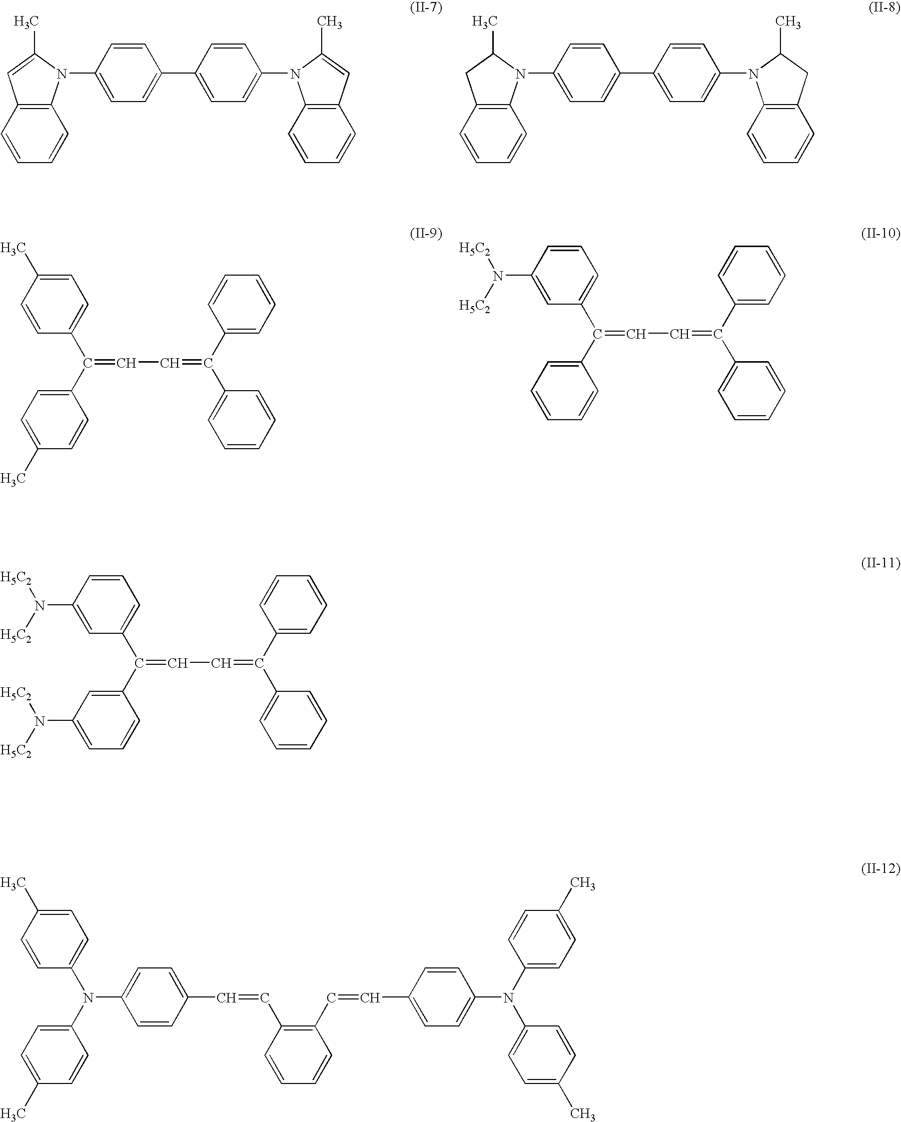

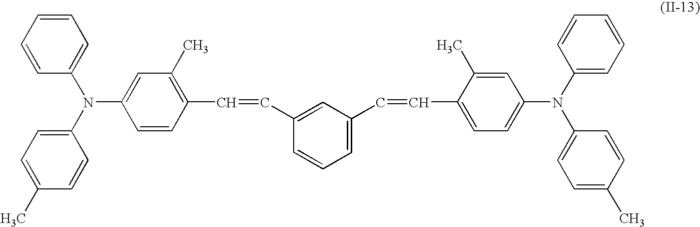

At least one of charge generation layer 4 and charge transport layer 5 in the photocohductor of the present invention is necessary to contain the compound represented by the formula (I). The compound of formula (I) is contained preferably in an amount of 0.01 to 20 parts by weight, more preferably 0.05 to 10 parts by weight with respect to 100 parts by weight of the charge generation material or the charge transport material. In a single-layer type photoconductor, the compound of formula (1) is contained preferably in an amount of 0.1 to 50 wt % more preferably 1 to 20 wt % with respect to a solid component of the photosensitive layer.

Various additives may be contained, as required, in undercoat layer 2, charge generation layer 4 and charge transport layer 5 for the purpose of increasing sensitivity, reducing residual potential, and improving stability to environmental conditions or against harmful light. In addition to the compound of formula (I) of the present invention, the additives to be used may be selected from succinic anhydride, maleic anhydride, dibromomaleic anhydride, pyromellitic anhydride, pyromellitic acid, trimellitic acid, trimellitic anhydride, phthalimide, 4-nitrophthalimide, tetracyanoethylene, tetracyanoquinodimethane, chloranyl, bromanyl, o-nitrobenzoic acid, and trinitrofluorenone. Further, an antioxidant or a photo-stabilizer may also be contained as an additive. The compound used for this purpose may be selected from chromanol derivative, such as tocopherol, and ether compound, ester compound, polyarylalkane compound, hydroquinone derivative, diether compound, benzophenone derivative, benzotriazole derivative, thioether compound, phenylene diamine derivative, phosphorus acid ester, phenol compound, hindered-phenol compound, linear amine compound, cyclic amine compound and hindered-amine compound. However, the additives shall not be limited to these exemplified substances.

Photosensitive layer 3 may further contain silicone oil or fluorine-containing oil for the purpose of improving flatness of the formed film and giving more lubricating ability.

Surface protective layer 6 may be provided on photosensitive layer 3, as needed, for the purposes of improving stability against environment and increasing mechanical strength. Surface protective layer 6 is formed of a material that has high durability against mechanical stress and high stability against environment. Surface protective layer 6 is desired to transmit light that is sensible by charge generation layer 4 with minimum loss.

Surface protective layer 6 is composed of a layer containing resin binder as a principal component or a inorganic thin film such as amorphous carbon. The resin binder may contain for the purpose of increasing conductivity, reducing friction coefficient and giving lubricity, metal oxide, such as silicon oxide that is silica, titanium oxide, tin oxide, calcium oxide, aluminum oxide that is alumina, or zirconium oxide, metal sulfide, such as barium sulfide or calcium sulfide, metal nitride, such as silicon nitride or aluminum nitride, fine particles of metal oxide, or particles of a fluorine-containing resin, such as tetrafluoroethylene resin, or a fluorine-containing comb-type graft copolymer resin.

Surface protective layer 6 may further contain the charge transport material and electron accepting material for the purpose of giving charge transport function to the protective layer, and also contain the compound of formula (I) involving the present invention. For improving flatness of the formed film and giving lubricating function to the protective layer, silicone oil or fluorine-containing oil may also be contained. The film thickness of surface protective layer 6 depends on the material composition used in this layer, and may be set to a desired value within a range in which the obtained photoconductor does not suffer from adverse influences, such as increase in the residual potential when repeatedly and continuously used.

Above-described effects of the photoconductor of the invention can be obtained when applied to various kinds of machine processes including charging processes of contact charging type using rollers or brushes, and non-contact charging type using corotron or scorotron, and developing processes of contact or non-contact developing type using non-magnetic one-component system, magnetic one-component system or two-component system. The compound of formula (I) in the present invention has enough effect not only in a negative-charging type photoconductor, which is now in a main stream of photoconductors of electrophotographic system, but also in a positive-charging type photoconductors.

A method of the invention for manufacturing a photoconductor is only necessary to comprise a step for forming a photosensitive layer by applying coating liquid that contains a compound represented by the general formula (I), and is not limited by any other condition in the manufacturing process.

### EXAMPLES

The invention will be described in further detail referring to examples of preferred embodiments thereof.

### Example 1

An undercoat layer having thickness of about 2 μm was formed by coating a conductive substrate with coating liquid by dip-coating method and drying at 100° C. for 30 min. The conductive substrate was an aluminum cylinder having an outer diameter of 30 mm and a length of 254 nun. The coating liquid for the undercoat layer was prepared by dissolving and dispersing 5 parts by weight of alcohol-soluble nylon: AMILAN CM8000 manufactured by Toray Industries Co., Ltd. and 5 parts by weight of fine particles of aminosilane-treated titanium oxide in 90 parts by weight of methanol.

A charge generation layer having thickness of about 0.3 μm was formed by coating the undercoat layer with coating liquid and drying at 80° C. for 30 min. The coating liquid for the charge generation layer was prepared by dispersing and dissolving 1.5 parts by weight of a charge generation material of X-type metal-free phthalocyanine and 1.5 parts by weight of a resin binder of poly(vinyl butyral) resin: BX-1 manufactured by Sekisui Chemical Co., Ltd. in 60 parts by weight of a mixture of dichloromethane and dichloroethane in equal mixing ratio.

A charge transport layer having thickness of about 25 μm was formed by coating the charge generation layer with coating liquid and dried at 90° C. for 60 min, to obtain a photoconductor. The coating liquid for the charge transport layer was prepared by dissolving 100 parts by weight of a charge transport material that is the compound represented by the formula (II-1) manufactured by Fuji Electric Co., Ltd., 100 parts by weight of a resin binder that is a polycarbonate resin: TOUGHZET B-500 manufactured by Idemitsu Kosan Co., Ltd., and one part by weight of the compound represented by the formula (I-1), in 900 parts by weight of dichloromethane.

### Example 2

A photoconductor was produced in the same manner as in Example 1 except that the compound represented by formula (I-1) was replaced by the compound represented by formula (I-3).

### Example 3

A photoconductor was produced in the same manner as in Example 1 except that the charge generation material was changed to α-type oxytitanylphthalocyanine.

### Example 4

A photoconductor was produced in the same manner as in Example 1 except that one part by weight of the compound represented by the formula (I-1) was contained in the charge generation layer, but not contained in the charge transport layer.

### Comparative Example 1

A photoconductor was produced in the same manner as in Example 1 except that the compound represented by the formula (I-1) was not used.

### Comparative Example 2

A photoconductor was produced in the same manner as in Example 3 except that the compound represented by the formula (I-1) was not used.

Electrophotographic characteristics of the Examples 1 to 4 and Comparative Examples 1 and 2 were evaluated as follows. A photoconductor surface was charge to −650 V by corona discharge in the dark and a surface potential immediately after the charging was measured as V0. Then the corona discharge was stopped. After holding in the dark for 5 sec, the surface potential was measured as V5. A potential retention rate Vk5 (%) at 5 sec after the charging is defined by

Vk5=V5/V0×100 (1)

Monochromatic light of wavelength of 780 nm separated using a filter from light of a halogen lamp was irradiated to a photoconductor for 5 sec from the time when the surface potential was −600 V. The amount of light energy irradiated in the period when the surface potential decayed from −600 V to −300 V was measured as sensitivity E(½) [μJ cm⁻²]. The surface potential after 5 sec of irradiation was measured as residual potential VR5 [−V]

Electrical characteristics of the Examples 1 to 4 and Comparative Examples 1 and 2 were evaluated by measuring above-described items at there different times: (1) initial, (2) immediately after 2 hr storage in a sealed vessel filled with 100 ppm of ozone and shut out external light, and (3) at 24 hr after taking out from the vessel. The measured results are given in Table 1.

TABLE 1

| | | | sensitivity | |
|---|---|---|---|---|
| | | potential retention | E(1/2) | residual potential |
| | | rate Vk5 (%) | (μJ cm⁻²) | VRS (−V) |
| Example 1 | initial | 96.5 | 0.37 | 33 |
| | immediately after ozone | 92.4 | 0.32 | 27 |
| | exposure | | | |
| | 24 hr after ozone exposure | 95.5 | 0.35 | 28 |
| Example 2 | initial | 95.8 | 0.35 | 31 |
| | immediately after ozone | 92.3 | 0.29 | 23 |
| | exposure | | | |
| | 24 hr after ozone exposure | 95.3 | 0.31 | 31 |
| Example 3 | initial | 94.7 | 0.20 | 18 |
| | immediately after ozone | 92.1 | 0.18 | 15 |
| | exposure | | | |
| | 24 hr after ozone exposure | 94.5 | 0.18 | 17 |
| Example 4 | initial | 96.8 | 0.42 | 41 |
| | immediately after ozone | 93.7 | 0.32 | 34 |
| | exposure | | | |
| | 24 hr after ozone exposure | 95.4 | 0.38 | 40 |
| Comp. Ex. 1 | initial | 96.8 | 0.38 | 40 |
| | immediately after ozone | 92.3 | 0.30 | 33 |
| | exposure | | | |
| | 24 hr after ozone exposure | 88.6 | 0.21 | 28 |
| Comp. Ex. 2 | initial | 92.3 | 0.20 | 17 |
| | immediately after ozone | 91.8 | 0.18 | 13 |
| | exposure | | | |
| | 24 hr after ozone exposure | 82.2 | 0.16 | 10 |

As clearly shown by the results in Table 1, when the compound of the formula (I) involved in the invention is contained in the charge transport layer or the charge generation layer, harmful influences of ozone exposure, such as reduction of potential retention rate and decrease of residual potential, are effectively suppressed, while initial electrical characteristics differs little as compared with the photoconductor that does not contain the compound of the formula (I).

Each of the photoconductors of the Examples and the Comparative Examples was mounted on a magnetic two-component development type digital copier that was modified so as to measure surface potential of a photoconductor, and stability of bright potential of the photoconductors was evaluated before and after 100 thousand sheets of printings. The results are given in Table 2.

TABLE 2

| | initial bright | bright potential after | |
|---|---|---|---|
| | potential (−V) | 10⁵ copies | difference (−V) |
| Example 1 | 58 | 63 | 5 |
| Example 2 | 56 | 58 | 2 |
| Example 3 | 40 | 46 | 6 |
| Example 4 | 67 | 74 | 7 |
| Comp. Example 1 | 50 | 102 | 52 |
| Comp. Example 2 | 42 | 75 | 33 |

As clearly shown in Table 2, while initial values of the bright potential are not much different between the Examples and the Comparative Examples, great differences have been observed after 100 thousand sheets of repeated printings between the Examples that used the compound of the formula (I) and comparative Examples that did not use the compound. It has been made clear that the compound of formula (I) suppresses rise of the bright potential.

### EFFECT OF THE INVENTION

As described so far, a photoconductor according to the present invention, which uses a specific compound represented by the formula (I) in the photosensitive layer thereof, improves resistance against ozone without adverse effect to the initial electrical characteristics. Moreover, the photoconductor of the invention exhibits stable electrical characteristics during repeated operation in the practical machine.

The photoconductor of the invention achieves enough effect in every system including various charging process and developing process, and negative charging and positive charging processes.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An electrophotographic photoconductor comprising:
a conductive substrate; and
a photosensitive layer on said conductive substrate, said photosensitive layer containing a compound represented by formula (I), 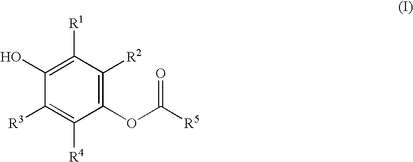
wherein each of R¹ to R⁴ are independently selected from the group consisting of a hydrogen atom, a halogen atom, an alkyl group of 1 to 4 carbon atoms, an alkoxyl group, an alkyl halide group, an alkoxyl halide group, or an optionally substituted aryl group, and R⁵ represents an optionally substituted alkyl group or an optionally substituted aryl group.

2. An electrophotographic photoconductor according to claim 1, wherein:
said photosensitive layer includes a charge generation layer and a charge transport layer, and
at least one of said charge generation layer and said charge transport layer contains said compound represented by formula (I).

3. An electrophotographic photoconductor according to claim 1, wherein:
said photosensitive layer consists of single layer; and
said compound represented by formula (I) is contained in an amount of 0.1 to 50 weight percent with respect to a solid component of said photosensitive layer.

4. An electrophotographic photoconductor according to claim 3, wherein said compound represented by formula (I) is contained in an amount of 1 to 20 weight percent with respect to a solid component of said photosensitive layer.

5. An electrophotographic photoconductor according to claim 2, wherein:
said charge generation layer includes charge generation material;
said charge transport layer includes charge transport material; and
said compound represented by formula (I) is contained in either said charge generation layer in an amount of 0.01 to 20 parts by weight with respect to 100 parts by weight of said charge generation material or said compound represented by formula (I) is contained in said charge transport layer in an amount of 0.01 to 20 parts by weight with respect to 100 parts by weight of said charge transport material.

6. An electrophotographic photoconductor according to claim 5, wherein said compound represented by formula (I) is contained in either said charge generation layer in an amount of 0.05 to 10 parts by weight with respect to 100 parts by weight of said charge generation material or said compound represented by formula (I) is contained in said charge transport layer in an amount of 0.05 to 10 parts by weight with respect to 100 parts by weight of said charge transport material.

7. A method for manufacturing an electrophotographic photoconductor comprising:
forming a photosensitive layer by coating a conductive substrate with coating liquid that contains a compound represented by formula (I), 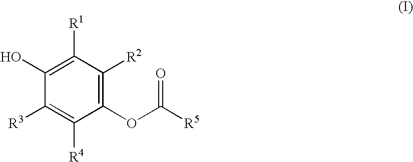
wherein each of R¹ to R⁴ are independently selected from the group consisting of a hydrogen atom, a halogen atom, an alkyl group of 1 to 4 carbon atoms, an alkoxyl group, an alkyl halide group, an alkoxyl halide group, or an optionally substituted aryl group, and R⁵ represents an optionally substituted alkyl group or an optionally substituted aryl group.
